(19) United States
(12) Patent Application Publication
(10) Pub. No.: US 2026/0118061 A1
(43) Pub. Date: Apr. 30, 2026

(54) BATCH FOR THE PRODUCTION OF A REFRACTORY UNFIRED MOLDED BODY, SUCH A MOLDED BODY, METHOD FOR ITS PRODUCTION, AND LINING OF A FURNACE AND FURNACE

(71) Applicant: Refratechnik Holding GmbH, München (DE)

(72) Inventors: Volker Stein, Göttingen (DE); Thomas Schemmel, Hünxe (DE)

(21) Appl. No.: 18/552,993

(22) PCT Filed: Mar. 17, 2022
(86) PCT No.: PCT/EP2022/057053

§ 371 Date: Dec. 2, 2024

(30) Foreign Application Priority Data
Apr. 1, 2021 (DE) 10 2021 203 371.7

(51) Int. Cl. F27D 1/00; C04B 28/04; C04B 28/06

(52) U.S. Cl. CPC F27D 1/0006; C04B 28/04; C04B 28/06

(57) ABSTRACT

The present invention relates to a dry refractory batch based on rice husk ash as an admixture for the production of a thermally insulating refractory unfired molded body, more particularly a brick or a plate; to a molded body of this type; to a method for producing the molded body; to various uses of the molded body, more particularly also to a lining having a molded body of this type; and to a furnace, more particularly an industrial furnace or a domestic stove, having a lining of this type.

The present invention relates to a dry, refractory batch based on rice husk ash as an aggregate for the production of a heat-insulating, refractory, unfired molded body, in particular a brick or a plate, as well as to such a molded body and a method for its production and the use of the batch. In addition, the invention relates to various uses of the molded body, in particular also to a lining with such a molded body and to a furnace, in particular an industrial furnace or a domestic furnace, with such a lining.

The term “refractory” in the context of the invention is not intended to be limited to the definition according to ISO 836 or DIN 51060, which define a pyrometric cone equivalent of >1500° C. Refractory products in the sense of the invention have a compression softening point T_{0.5} according to DIN EN ISO 1893:2009-09 of T_{0.5}≥600° C., preferably T_{0.5}≥800° C. Accordingly, refractory or fire-resistant grainy materials or granular materials in the sense of the invention are those materials or granular materials which are suitable for a refractory product with the above-mentioned compression softening point T_{0.5}. The refractory products according to the invention are used for the protection of aggregate structures in aggregates in which temperatures between 60° and 2000° C., in particular between 100° and 1800° C. predominate.

In this context, the term “granular material” or “grainy material” in the sense of the invention includes a pourable solid material consisting of many small, solid grains. If the grains have a grain size ≤200 μm, the granular material is a meal or powder. The grains are produced, for example, by mechanical comminution, e.g. crushing and/or grinding. The grain size distribution of the granular material is usually adjusted by sieving.

DE 10 2016 112 044 A1 discloses the use of an unfired, refractory molded body comprising a binder matrix containing at least one set, permanent binder and aggregate grains with and/or of biogenic silica, preferably with and/or of rice husk ash, which are incorporated in the binder matrix, for thermal insulation of a molten metal, in particular a molten steel, and/or of a metallic cast ingot solidifying from the molten metal. In addition, DE 10 2016 112 044 A1 discloses the use of the molded body for thermal insulation of a refractory lining, in particular in a multilayer masonry or in a heat treatment furnace, or as a corrosion barrier, e.g. against alkali attack, or as a fire protection lining or as a filter material for hot gases. The at least one permanent binder may be an inorganic binder, preferably water glass or a sol-gel binder or a phosphate binder or alumina cement or Portland cement. In addition, the molded body according to DE 10 2016 112 044 A1 may comprise microsilica, expanded perlite and/or expanded vermiculite and/or expanded clay and/or inorganic fibers, preferably mineral and/or slag and/or glass and/or ceramic fibers, and/or fly ash and/or (power plant) filter dust. The cold compressive strength of the molded body is preferably 1.5 to 20.0 MPa, preferably 2.5 to 15.0 MPa according to DIN EN 993-5 (December 1998).

The well-known refractory molded body has proven its worth. However, very high mechanical strength requirements are placed on such molded bodies, especially when they are used in moving units.

The object of the present invention is to provide a dry, refractory batch for the production of a heat-insulating, refractory, unfired molded body, in particular a brick or plate, which has improved mechanical properties and at the same time good heat-insulating properties and is highly refractory.

A further object of the invention is to provide such a molded body and a method of producing it, and to indicate various uses of the molded body.

These objects are solved by a batch with the features of claim 1, a use with the features of claim 13, a method with the features of claim 14 as well as a molded body with the features of claim 24, a lining with the features of claim 28, a lining with the features of claim 31, a furnace with the features of claim 34 and an aggregate with the features of claim 38. Advantageous further embodiments of the invention are characterized in the following subclaims.

In the following, the invention is explained in more detail with the aid of a drawing by way of example. It shows:

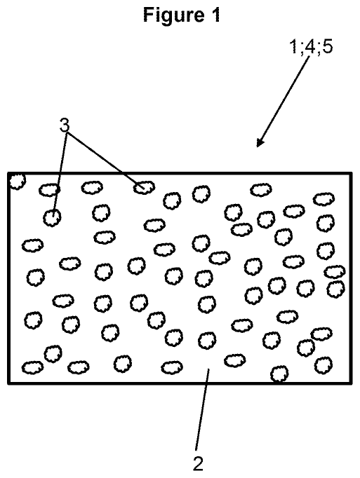

FIG. 1: Schematically and highly simplified a cross section through a brick according to the invention

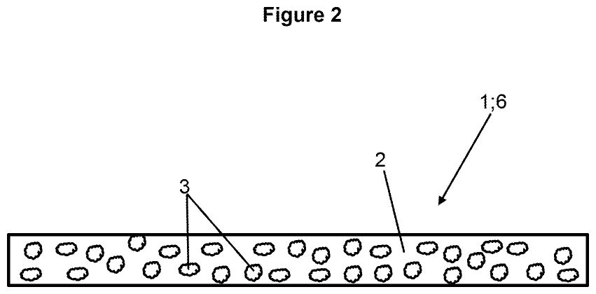

FIG. 2: Schematically and highly simplified a cross-section of a plate according to the invention

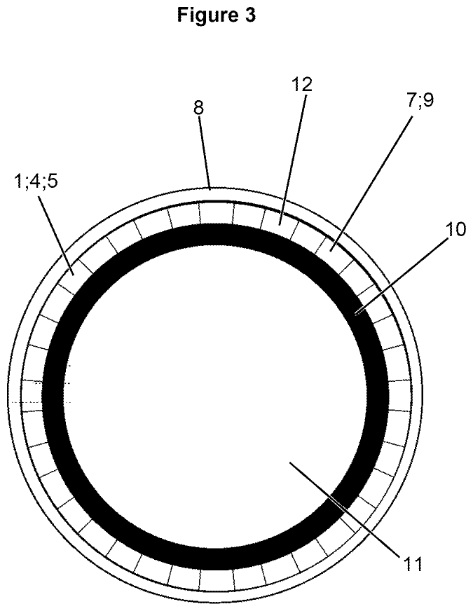

FIG. 3: Schematically and highly simplified a cross-section of a lining of a furnace with masonry bricks according to the invention

The unfired molded body 1 according to the invention (FIGS. 1-3) comprises a binder matrix 2 in which aggregate grains 3 of rice husk ash are embedded or incorporated. The aggregate grains 3 are distributed in the binding matrix 2. Preferably, the molded body 1 is a brick 4, in particular a masonry brick 5, or a plate 6.

According to the invention, the binding matrix 2 consists of a set or hardened mixture containing, preferably consisting of, Portland cement and/or alumina cement and a fine-particle, preferably amorphous, SiO₂ component.

As a result, the molded body 1 according to the invention is produced from a dry batch comprising a cement component of Portland cement and/or alumina cement, the fine-particle, preferably amorphous, SiO₂ component and, as an aggregate, rice husk ash.

After the addition of mixing water, the cement component and the SiO₂ component form the binding matrix 2. The cement component and the SiO₂ component together can thus be described as the binding component of the batch.

Preferably, the batch comprises 5 to 40 ma.-%, preferably 5 to 35 ma.-% or 10 to 35 ma.-%, particularly preferably 5 to 30 ma.-%, cement component and/or 5 to 40 ma.-%, preferably 5 to 35 ma.-% or 10 to 35 ma.-%, particularly preferably to 30 ma.-%, SiO₂ component and/or 25 to 70 ma.-%, preferably 25 to 60 ma.-%, particularly preferably 30 to 55 ma.-%, rice husk ash aggregate.

Preferably, the batch consists of at least 90 ma.-%, preferably of at least 95 ma.-%, more preferably of at least 98 ma.-%, and most preferably of 100 ma.-% or exclusively of the cement component, the SiO₂ component and the rice husk ash.

The amount of further or other constituents in addition to the cement component, the SiO₂ component and the rice husk ash is thus preferably <10 ma.-%, preferably <5 ma.-%, particularly preferably >2 ma.-%.

Thus, the batch preferably comprises 25 to 70 ma.-%, preferably 25 to 60 ma.-%, particularly preferably 30 to 55 ma.-%, aggregate of rice husk ash, and the remainder of the batch consists of the binding component, i.e. the cement component and the SiO₂ component, and optionally the other constituents.

Preferably, the amount of cement component and SiO₂ component in the batch respectively is at least 5 ma.-%.

The other constituents may be, in particular, perlite and/or a burnout material, and/or diatomaceous earth, and/or fly ash.

It is known that standardized Portland cement (CEM I) according to DIN EN 197-1:2011-11 consists of 95-100 ma.-% Portland cement clinker and 0-5 ma.-% minor constituents. In addition, Portland cement (CEM I) contains a sulfate carrier as a setting regulator.

In the context of the invention, Portland cement is understood to be a mixture of Portland cement clinker, possibly the minor constituents and the sulfate carrier. In this sense, the other standardized cements according to DIN EN 197-1:2011-11 are Portland cement in combination with the respective additional main constituent(s) or a mixture of Portland cement and the respective additional main constituent(s). The further main constituent(s) are thus other constituents of the batch according to the invention. If the additional main constituent is silica fume (e.g. CEM II A-D) or another SiO₂ component according to the invention, this is of course attributed to the SiO₂ component.

Alumina cement (CAC) is standardized in DIN EN 14647:2006-01. In contrast to the silicate cements, the alumina cement clinker consists essentially of monocalcium aluminate (CA). Alumina cement consists of alumina cement clinker and, if necessary, grinding aids. However, their amount is ≥0.2 ma.-%.

Preferably, the cement component consists of at least 90 ma.-%, preferably exclusively, of Portland cement.

As already explained, the SiO₂ component is very fine-particle or powdery. The specific surface area according to DIN ISO 9277:2014-01 is 10 to 230 m²/g, preferably 10 to 100 m²/g, particularly preferably 15 to 60 m²/g.

The SiO₂ component preferably comprises a grain size or particle size ≤200 μm, preferably ≤150 μm, determined according to ISO 13320:2020-01. That is, it is contained in particular exclusively in a particle size ≤200 μm, preferably ≤150 μm.

In addition, the primary particles (=deagglomerated individual particles) of the individual grains of the SiO₂ component preferably comprise a grain size or particle size of 0.1 to 0.2 μm, determined according to ISO 13320:2020-01.

Furthermore, the SiO₂ component has a content of SiO₂≥85 ma.-% determined according to DIN EN ISO 12677:2013-02.

Amorphous means that the SiO₂ component contains more amorphous SiO₂ than crystalline SiO₂, determined by quantitative Riedveld analysis. Here, a defined amount of an internal standard of known composition is added to the sample to be analyzed. The sample prepared in this way is then examined in an Xray diffractometer. The amorphous amount of the sample is then calculated using Rietveld analysis on the measurement file (diffraction image of the sample) (see e.g. “Quantitative Rietveld analysis of amorphous materials using the example of blast furnace slags and fly ashes”, Torsten Westphal, 2007).

Furthermore, the SiO₂ component preferably has a bulk density of 0.2 to 0.7 g/cm³, preferably 0.25 to 0.6 g/cm³, determined according to DIN EN ISO 60:2000-01.

The SiO₂ component can consist of one or more, preferably amorphous, SiO₂ raw materials. The SiO₂ raw materials naturally also comprise the properties specified for the SiO₂ component (SiO₂ content, grain size or specific surface area, density, etc.).

Preferably, the SiO₂ component consists of microsilica and/or fumed silica and/or precipitated silica. Particularly preferably, the SiO₂ component consists of at least 90 ma.-%, preferably exclusively, of microsilica.

Microsilica (silica fume) is formed as a by-product during the reduction of high-purity quartz with carbon in electric arc furnaces during the production of silicon and ferrosilicon alloys. Microsilica consists of very fine spherical particles.

Pyrogenic silica (fumed silica) is a synthetically produced colloidal material consisting of amorphous silica grains or silica particles aggregated into larger units. It is produced by high-temperature pyrolysis.

Precipitated silica (precipitated silica) is a white powdery material produced by precipitation from a silicate-containing solution.

According to the invention, the aggregate grains 3 also consist of rice husk ash, which has a significantly lower carbon content than conventional rice husk ash. According to the invention, the rice husk ash has a carbon content ≤3 ma.-%, preferably ≤1.5 ma.-%, particularly preferably ≤0.5 ma.-%, most preferably ≤0.2 ma.-%, determined according to DIN 51075-2:1984-03.

In contrast, conventional rice husk ash has a carbon content of 4 to 15 ma.-%, determined according to DIN 51075-2:1984-03. Due to its high carbon content, conventional rice husk ash has a black color.

In contrast, the low-carbon rice husk ash according to the invention has a light color, for example a light gray or even pink.

In the context of the invention, it was surprisingly found out that the use of the low-carbon rice husk ash in combination with the fine-particle SiO₂ component leads to a significantly improved cold bending strength of the molded body 1 according to the invention, while in particular the heat-insulating properties are retained. This will be discussed in more detail below.

The low-carbon rice husk ash according to the invention is produced, for example, by thermal treatment of conventional black, i.e. high-carbon, rice husk ash at temperatures of at least 1300° C., preferably at least 1400° C. The carbon contained in the rice husk ash is oxidized to a large extent so that the rice husk ash initially takes on a gray and finally a light pink color. Or it is fired directly at these temperatures.

The rice husk ash according to the invention also preferably comprises the following chemical composition according to DIN EN ISO 12677 (February 2013), with the individual constituents adding up (without loss on ignition) to 100% by weight:

amount [ma.-%]

| | | preferably |
|---|---|---|
| SiO₂ | 91.5 to 98 | 93.5 to 97 |
| P₂O₅ | 0.5 to 2.0 | 0.5 to 1.5 |
| K₂O + Na₂O | 1.0 to 3.5 | 1.5 to 3.0 |
| Residual oxides | 0.5 to 3.0 | 1.0 to 2.0 |

The carbon content is not included in the chemical analysis, since according to DIN EN ISO 12677:2013-02 the analysis is performed on annealed or molten substance.

Furthermore, the rice husk ash preferably has the following grain size distribution according to DIN 66165-2 (April 1987) based on the dry mass, with the individual components adding up to 100% by weight:

amount [ma.-%]

| grain size [mm] | | preferably |
|---|---|---|
| >2.0 | 0 to 3.0 | 0.01 to 0.5 |
| >1.0-2.0 | 1.0 to 7.0 | 2.0 to 6.0 |
| >0.5-1.0 | 5.0 to 15.0 | 6.0 to 10.0 |
| >0.3-0.5 | 12.0 to 22.0 | 14.0 to 20.0 |
| >0.1-0.3 | 30.0 to 50.0 | 32.0 to 45.0 |
| ≤0.1 | 20.0 to 40.0 | 25.0 to 35.0 |

In addition, the rice husk ash preferably comprises a d₉₀ value of 350 to 650 μm, preferably 400 to 600 μm, and/or a d₅₀ value of 100 to 400 μm, preferably 150 to 350 μm, according to DIN 66165-2 (April 1987). The rice husk ash according to the invention is thus somewhat finer than conventional rice husk ash and thus also improves the cold compressive strength.

The bulk density according to DIN EN 1097-3 (June 1998) of the rice husk ash is preferably 200 to 600 kg/m³, especially 300 to 500 kg/m³, particularly preferably 350 to 450 kg/m³.

In addition, the rice husk ash according to the invention has a somewhat different structure than the high-carbon rice husk ash. While high-carbon rice husk ash has a relatively coarse, porous and long-needled structure, the low-carbon rice husk ash according to the invention is finer-grained, somewhat denser and less needle-like.

The production of the molded article 1 according to the invention from the dry batch according to the invention is now carried out as follows:

First, the dry batch ingredients are mixed together.

Mixing water is then added to the dry mixture. Preferably, the amount of mixing water is 10 to 40 ma.-%, preferably 15 to 30 ma.-%, based on the mass of the dry components of the mixture or the mass of the dry batch.

Surprisingly, it was found out in the context of the invention that the relatively high mixing water content can also help to improve the cold compressive strength.

It is also within the scope of the invention to use the SiO₂ component in the form of an aqueous dispersion and to mix this with the other dry constituents. However, addition in dry form is preferred.

The finished aqueous mixture, comprising the cement component, the SiO₂ component, the rice husk ash and the water, is then placed in a mold and compacted therein. The compaction is preferably carried out by uniaxial pressing. However, it can also be carried out by means of superimposed vibration.

In superimposed vibration, the mold is located on a vibration table. A weight is placed on the finished mixture in the mold, the vibrating table is activated and the mixture is compacted by vibration. Smaller formats are usually produced by means of superimposed vibration.

In uniaxial pressing, the mold filled with the finished mixture is placed in a press, wherein a cover plate is placed on the mixture. The upper die of the press is then moved against the cover plate, thus compacting the mixture with a specific pressure. Preferably, several press strokes are carried out. Larger formats are generally produced by uniaxial pressing. The compression ratio (press stroke) of the press mass is preferably between 2.5 and 3.5.

After compacting, the green-strengthen molded body is demolded and allowed to set. Since the molded body 1 according to the invention is unfired, setting takes place in a manner known per se below the temperature for ceramic firing. Preferably, the molded bodies are allowed to set at room temperature for a period of 20 to 48 h. Preferably, the set molded bodies are then dried, in particular to constant weight.

As explained above, the molded body 1 according to the invention comprises an excellent cold compressive strength combined with high refractoriness and outstanding thermal insulation properties.

According to the invention, the cold compressive strength of the molded body 1 is 18 to 40 MPa, preferably >20 to 35 MPa, particularly preferably 22 to 35 MPa according to DIN EN 993-5 (December 1998).

In addition, the molded body 1 preferably has a softening temperature determined with a heating microscope according to DIN EN 51730 (September 2007) of 1000 to 1700° C., preferably 1250 to 1650° C. Thus, the molded body 1 is suitable for lasting or permanent use at very high temperatures. The high softening temperature also results, among other things, from the use of the fine-particle SiO₂ component, as a result of which the cement component content could be reduced.

In addition, the molded body 1 preferably comprises a porosity of 30 to 90%, preferably 40 to 60% according to DIN EN 1094-4 (September 1995). The high porosity results in particular from the high amount of rice husk ash and its high microporosity. Because of that, even the very fine particles of the SiO₂ component surprisingly do not penetrate into the aggregate grains 3 of rice husk ash, so that their porosity is maintained.

Particularly also due to the high porosity, the molded body 1 has a very low thermal conductivity. Preferably, the molded body 1 has the following thermal conductivities according to DIN EN 993-15 (July 2005):

TC [W/mK]

| | | preferably |
|---|---|---|
| at 307° C. | 0.20 to 0.40 | 0.25 to 0.35 |
| at 700° C. | 0.20 to 0.40 | 0.25 to 0.35 |
| at 995° C. | 0.25 to 0.45 | 0.26 to 0.36 |

The molded body 1 according to the invention also preferably has a dry bulk density po of 0.3 to 1.5 g/cm³, preferably of 0.5 to 1.4 g/cm³, according to DIN EN 1094-4 (September 1995).

And the cold bending strength of the molded body 1 is preferably 1.0 to 9.0 MPa, preferably 1.5 to 7.0 MPa, according to DIN EN 993-6 (April 1995).

The hot bending strength at 1000° C. of the molded body 1 is preferably 1.0 to 7.0 MPa, preferably 1.5 to 5.0 MPa, according to DIN EN 993-7 (April 1995).

The SiO₂ content according to DIN EN ISO 12677 (February 2013) of the molded body 1 according to the invention is preferably in the range of 65 to 90 ma.-%.

Due in particular to its high cold bending strength, the molded body 1 according to the invention is eminently suitable for use in furnaces, especially large-volume industrial furnaces, in which the molded bodies 1 are subjected to high dynamic loads.

The, in particular large-volume, industrial furnace is preferably a burning kiln or a melting furnace or a furnace for energy generation or a heat treatment furnace, e.g. an annealing furnace. Preferably, these furnaces are respectively furnaces of the non-metal industry or the metal industry, in particular the steel industry or the non-ferrous metal industry.

In particular, it is a waste incineration furnace, a glass melting furnace, a furnace of the ceramic industry, a furnace of the paper industry, a shaft furnace or a rotary kiln, preferably a cement shaft furnace or a cement rotary kiln, a lime shaft furnace or a lime rotary kiln, a magnesite shaft furnace or a magnesite rotary kiln, or a dolomite shaft furnace or a dolomite rotary kiln.

In addition, it can also advantageously be a steelmaking furnace, in particular an electric arc furnace. This is used in particular for melting steel scrap.

A furnace usually has an outer furnace shell 8 surrounding a furnace interior 11. In addition, the furnace has a refractory lining 9 lining the inside of the furnace shell. The lining 9 serves to insulate the kiln shell 8 from the kiln interior 11, in particular thermally.

A generic industrial furnace generally has a multi-layer masonry 7 (FIG. 3), which is surrounded by the outer furnace shell 8. The multi-layer masonry 7 lines the inside of the kiln shell 8 and forms the refractory lining 9 of the industrial kiln.

The multi-layer masonry 7 also has a fire-sided or hot-sided working casing or aggregate inner casing 10, which is in direct contact with or closes off a kiln interior 11. Between the furnace shell 8 and the working casing 10 there is an insulating layer or insulating backing or insulating casing 12. This serves to thermally insulate the kiln shell 8 from the working casing 10. Furthermore, an intermediate casing (not shown) may be present between the working casing 10 and the insulating casing 12.

The working casing 10 may be formed of refractory masonry bricks in a manner known per se, or it may be a monolithic refractory lining.

According to the invention, at least the insulating casing 12 now comprises or consists of masonry bricks 5 (FIG. 3) and/or plates 6 (not shown) according to the invention. In addition, the intermediate casing can also have masonry bricks 5 (FIG. 3) and/or plates 6 (not shown) according to the invention or consist of these.

Furthermore, the lining 9 can also be a single-shell or single-layer lining 9, in particular a single-layer masonry or single-shell masonry (not shown). The single-shell lining 9 thus serves simultaneously as a working casing and for thermal insulation of the kiln shell 8 from the kiln interior 11. According to the invention, the single-shell lining 9 now has or consists of masonry bricks 5 and/or plates 6 according to the invention.

Furthermore, the lining may also be a lining of an aggregate or metallurgical vessel of the metal industry, in particular the steel industry or the non-ferrous metal industry, for receiving and/or transporting and/or treating liquid metal, in particular steel. These aggregates are thus transport vessels and/or treatment vessels and/or tundishes, preferably converters, ladles or distribution launders.

The molded bricks 1 according to the invention, preferably the masonry bricks 5 and/or plates 6, can also be used particularly advantageously in an analogous manner for lining a domestic furnace, preferably a fireplace stove.

As explained above, the molded body 1 according to the invention comprises an excellent cold bending strength combined with high refractoriness and outstanding thermal insulation properties.

Despite the cement bond and the basic character, the molded bodies 1 according to the invention also surprisingly have a high acid resistance.

These properties apparently result from the combination of the low-carbon rice husk ash, the cement component, in particular the Portland cement, and the SiO₂ component according to the invention and, in addition, preferably the mixing water component. However, the advantages of the combination according to the invention have not yet been clarified. In particular, in comparative tests with microsilica and conventional, high-carbon rice husk ash, it was not possible to achieve such a significant increase in strength as with the low-carbon rice husk ash.

Finally, it is pointed out that all of the above-mentioned, in particular claimed, features, in particular of the batch and/or of the molded body and/or of the lining and/or of the furnace and/or of the method, are particularly advantageous in themselves and in any combination and are the subject of the present invention.

In addition, the respective upper and lower limits of the individual range specifications can all be combined with each other according to the invention.

### EXEMPLARY EMBODIMENT

A plate according to the invention was produced from a batch with the following composition by uniaxial pressing:

| | amount [ma.-%] |
|---|---|
| portland cement (CEM \| 42.5) | 19 |
| microsilica 955 ∪ | 19 |
| rice husk ash Silimat GS | 62 |
| water* | 25 |

*Dry mixture without water in total 100%

The finished mixture was compacted by a factor of 3. The plate had the following dimensions: 800×800×64 mm³. The plate produced had the following properties:

| | | |
|---|---|---|
| dry bulk density ρ₀ (DIN EN 1094-4 (09/1995)) | 1.26 | g/cm³ |
| porosity (DIN EN 1094-4 (09/1995)) | 55 | vol.-% |
| cold compressive strength (DIN EN 993-5 | 24.5 | N/mm² |
| (12/1998)) | | |
| cold bending strength (DIN EN 993-6 (04/1995)) | 5.0 | N/mm² |
| softening temperature (DIN EN 51730 (09/2007) | 1431° | C. |

In addition, another plate according to the invention was produced from a batch with the following composition by uniaxial pressing:

| | amount [ma.-%] |
|---|---|
| portland cement (CEM \| 42.5) | 30 |
| microsilica 955 ∪ | 20 |
| rice husk ash Silimat GS | 50 |
| water* | 20 |

*Dry mixture without water in total 100%

The finished mixture was compacted by a factor of 3. The plate had the following dimensions: 800×800×64 mm³. The plate produced had the following properties:

| dry bulk density ρ₀ (DIN EN 1094-4 (09/1995)) | 1.36 g/cm³ |
|---|---|
| cold compressive strength (DIN EN 993-5 | 34.1 N/mm² |
| (12/1998)) | |

1. Dry batch for the production of a refractory, unfired molded body (1), preferably a brick (4), in particular a masonry brick (5), or a plate (6), comprising
a) a cement component of Portland cement and/or alumina cement,
b) a fine-particle, preferably amorphous, SiO₂ component with a specific surface area according to DIN ISO 9277:2014-01 of 10 to 230 m²/g, preferably 10 to 100 m²/g, particularly preferably 15 to 60 m²/g, and/or with a grain size ≤200 μm, preferably ≤150 μm, determined according to ISO 13320:2020-01,
c) aggregate of rice husk ash, wherein the rice husk ash has a carbon content ≤3 ma.-%, preferably ≤1.5 ma.-%, particularly preferably ≤0.5 ma.-%, most preferably ≤0.2 ma.-%, according to DIN 51075-2:1984-03.

2. Batch according to claim 1,
characterized in that
the batch consists of at least 90 ma.-%, preferably of at least 95 ma.-%, particularly preferably of at least 98 ma.-%, and most preferably exclusively of the cement component, the SiO₂ component and the rice husk ash.

3. Batch according to claim 1 or 2,
characterized in that
the batch comprises the rice husk ash in an amount of 25 to 70 ma.-%, preferably 25 to 60 ma.-%, particularly preferably 30 to 55 ma.-%.

4. Batch according to any one of the preceding claims,
characterized in that
the batch comprises an amount of SiO₂ component and cement component respectively of at least 5 ma.-%.

5. Batch according to any one of the preceding claims,
characterized in that
the batch comprises the cement component in an amount of 5 to 40 ma.-%, preferably 5 to 35 ma.-% or 10 to 35 ma.-%, particularly preferably 10 to 30 ma.-%.

6. Batch according to any one of the preceding claims,
characterized in that
the batch comprises the SiO₂ component in an amount of 5 to 40 ma.-%, preferably 5 to 35 ma.-% or 10 to 35 ma.-%, particularly preferably 10 to 30 ma.-%.

7. Batch according to any one of the preceding claims,
characterized in that
the cement component consists of at least 90 ma.-%, preferably exclusively, of Portland cement.

8. Batch according to any one of the preceding claims,
characterized in that
the SiO₂ component consists of at least one, preferably amorphous, SiO₂ raw material, the at least one SiO₂ raw material preferably being microsilica and/or fumed silica and/or precipitated silica.

9. Batch according to any one of the preceding claims,
characterized in that
the SiO₂ component consists of at least 90 ma.-%, preferably exclusively, of microsilica.

10. Batch according to any one of the preceding claims,
characterized in that
the SiO₂ component has an SiO₂ content ≥85 ma.-%, determined according to DIN EN ISO 12677:2013-02.

11. Batch according to any one of the preceding claims,
characterized in that
the rice husk ash has a bulk density according to DIN EN 1097-3 (June 1998) of 200 to 600 kg/m³, preferably 300 to 500 kg/m³, particularly preferably 350 to 450 kg/m³.

12. Batch according to any one of the preceding claims,
characterized in that
the rice husk ash has a d₉₀ value of 350 to 650 μm, preferably 400 to 600 μm, and/or a d₅₀ value of 100 to 400 μm, preferably 150 to 350 μm.

13. Use of a batch according to any one of the preceding claims for the production of a refractory, unfired molded body (1), preferably a brick (4), in particular a masonry brick (5), or a plate (6).

14. Method for the production of a refractory, unfired molded body (1), preferably a brick (4), in particular a masonry brick (5), or a plate (6), preferably from a batch according to any one of claims 1 to 12,
characterized by
following method steps:
a) Preparing a mixture comprising a cement component of Portland cement and/or alumina cement, a fine-particle SiO₂ component with a specific surface area according to DIN ISO 9277:2014-01 of 10 to 230 m²/g, preferably 10 to 100 m²/g, particularly preferably 15 to 60 m²/g, and/or with a grain size ≤200 μm, preferably ≤150 μm, determined according to ISO 13320:2020-01, aggregate of rice husk ash, wherein the rice husk ash comprises a carbon content ≤3 ma.-%, preferably ≤1.5 ma.-%, particularly preferably ≤0.5 ma.-%, most preferably ≤0.2 ma.-%, according to DIN 51075-2:1984-03, and water,
b) Filling the mixture into a mold,
c) Compacting the mixture,
d) Demolding of the green-strengthen molded body (1),
e) Allowing the molded body (1) to set,
f) Preferably, allowing the molded body (1) to dry.

15. Method according to claim 14,
characterized in that
a mixture having a water content of 10 to 40 ma.-%, preferably 15 to 30 ma.-%, based on the mass of the dry constituents of the mixture is prepared.

16. Method according to claim 14 or 15,
characterized in that
compacting of the mixture is carried out by means of uniaxial pressing.

17. Method according to any one of claims 14 to 16,
characterized in that
a molded body (1) with a cold compressive strength of 18 to 40 MPa, preferably of ≥20 to 35 MPa, particularly preferably of 22 to 35 MPa, is produced in accordance with DIN EN 993-5 (December 1998).

18. Method according to any one of claims 14 to 17,
characterized in that
a molded body (1) having a softening temperature determined with a heating microscope in accordance with DIN EN 51730 (September 2007) of 1000 to 1700° C., preferably 1250 to 1650° C., is produced.

19. Method according to any one of claims 14 to 18,
characterized in that
a molded body (1) with a dry bulk density po of 0.3 to 1.5 g/cm³, preferably of 0.5 to 1.4 g/cm³ according to DIN EN 1094-4 (September 1995), is produced.

20. Method according to any one of the claims 14 to 19,
characterized in that
a molded body (1) with a porosity of 30 to 90%, preferably 40 to 60%, according to DIN EN 1094-4 (September 1995) is produced.

21. Method according to any one of claims 14 to 20,
characterized in that
a molded body (1) with a cold bending strength of 1.0 to 9.0 MPa, preferably 1.5 to 7.0 MPa, according to DIN EN 993-6 (April 1995) is produced.

22. Method according to any one of the claims 14 to 21,
characterized in that
a molded body (1) with a hot bending strength at 1000° C. of 1.0 to 7.0 MPa, preferably of 1.5 to 5.0 MPa, according to DIN EN 993-7 (April 1995) is produced.

23. Method according to any one of claims 14 to 22,
characterized in that
a molded body (1) is produced which has the following thermal conductivities TC according to DIN EN 993-15 (July 2005):
TC [W/mK]

| | | preferably |
|---|---|---|
| at 307° C. | 0.20 to 0.40 | 0.25 to 0.35 |
| at 700° C. | 0.20 to 0.40 | 0.25 to 0.35 |
| at 995° C. | 0.25 to 0.45 | 0.26 to 0.36 |

24. Refractory, unfired molded body (1), preferably brick (4), in particular masonry brick (5), or plate (6), preferably produced from a batch according to any one of claims 1 to 12, comprising
a) a binding matrix (2) of a set mixture containing a cement component of Portland cement and/or alumina cement, and at least one fine-particle SiO₂ component with a specific surface area according to DIN ISO 9277:2014-01 of 10 to 230 m²/g, preferably 10 to 100 m²/g, particularly preferably 15 to 60 m²/g, and/or with a grain size <200 μm, preferably <150 μm, determined according to ISO 13320:2020-01,
b) aggregate grains (3) of rice husk ash distributed in and incorporated into the binding matrix (2), wherein the rice husk ash comprises a carbon content ≤3 ma.-%, preferably ≤1.5 ma.-%, particularly preferably ≤0.5 ma.-%, most preferably ≤0.2 ma.-% according to DIN 51075-2:1984-03.

25. Molded body (1) according to claim 24,
characterized by
the molded body (1) comprises 25 to 70 ma.-%, preferably 25 to 60 ma.-%, preferably 30 to 55 ma.-%, of rice husk ash, based on the dry mass of the molded body (1).

26. Molded body (1) according to claim 24 or 25,
characterized by
the molded body (1) comprises an SiO₂ content according to DIN EN ISO 12677 (February 2013) of 65 to 90 ma.-%.

27. Molded body (1) according to any one of claims 24 to 26,
characterized by
the molded body (1) is produced according to one of claims 14 to 23.

28. Refractory, in particular single- or multi-shell, lining (9) of a furnace, preferably an industrial furnace, preferably a burning kiln or a melting furnace or a furnace for power generation or a heat treatment furnace, or lining (9) of a domestic furnace,
characterized in that
the lining (9) comprises at least one molded body (1) according to any one of claims 24 to 27 and/or produced according to any one of claims 14 to 23.

29. Lining (9) according to claim 28,
characterized in that
the industrial furnace is a furnace of the non-metal industry or the metal industry, in particular the steel industry or the non-ferrous metal industry.

30. Lining (9) according to claim 28 or 29,
characterized in that
the industrial furnace is a waste incineration furnace or a glass melting furnace or a furnace of the ceramic industry or a furnace of the paper industry or a shaft furnace or a rotary kiln, preferably a cement shaft furnace or a cement rotary kiln, a lime shaft furnace or a lime rotary kiln, a magnesite shaft furnace or a magnesite rotary kiln or a dolomite shaft furnace or a dolomite rotary kiln, or a furnace of steel production, preferably an electric arc furnace.

31. Refractory, in particular single- or multi-shell, lining (9) of an aggregate or metallurgical vessel of the metal industry, in particular the steel industry or the non-ferrous metal industry, for receiving and/or transporting and/or treating liquid metal, in particular steel, preferably of a converter, a ladle or a distribution launder,
characterized in that
the lining (9) comprises at least one molded body (1) according to any one of claims 24 to 27 and/or produced according to any one of claims 14 to 23.

32. Lining (9) according to any one of claims 28 to 31,
characterized in that
the lining (9) comprises a fire-sided working casing (10) and an insulating casing (12) insulating the working casing (10), and the working casing (10) comprises the at least one molded body (1).

33. Lining (9) according to any one of claims 28 to 32,
characterized in that
the lining (9) comprises a fire-sided working casing (10) and an insulating casing (12) insulating the working casing (10), and the lining (9) comprises, between the working casing (10) and the insulating casing (12), an intermediate casing comprising the at least one molded body (1).

34. Furnace, preferably industrial furnace, preferably burning kiln or melting furnace or furnace for power generation or heat treatment furnace, or domestic furnace, comprising a furnace shell (8) and a refractory, in particular single-shell or multi-shell, lining (9) lining the latter,
characterized in that
the furnace comprises a lining (9) according to one of claims 28, 32 or 33.

35. Furnace according to claim 34,
characterized in that
the industrial furnace is a furnace of the non-metal industry or the metal industry, in particular the steel industry or the non-ferrous metal industry.

36. Furnace according to claim 34 or 35,
characterized in that
the industrial furnace is a waste incineration furnace or a glass melting furnace or a furnace of the ceramic industry or a furnace of the paper industry or a shaft furnace or a rotary kiln, preferably a cement shaft furnace or a cement rotary kiln, a lime shaft furnace or a lime rotary kiln, a magnesite shaft furnace or a magnesite rotary kiln or a dolomite shaft furnace or a dolomite rotary kiln, or a furnace of steel production, preferably an electric arc furnace.

37. Furnace according to claim 34,
characterized in that
the domestic furnace is a fireplace stove.

38. Aggregate or rather metallurgical vessel of the metal industry, in particular the steel industry or the non-ferrous metal industry, for receiving and/or transporting and/or treating liquid metal, in particular steel, preferably converter, ladle or distribution trough,
characterized in that
the aggregate comprises a lining (9) according to one of claims 28, 32 or 33.
